(19) United States
(12) Patent Application Publication
(10) Pub. No.: US 2019/0295733 A1
(43) Pub. Date: Sep. 26, 2019

(54) Plasma Compression Fusion Device

(71) Applicant: SALVATORE PAIS, Callaway, MD (US)

(72) Inventor: SALVATORE PAIS, Callaway, MD (US)

(73) Assignee: United States of America as represented by the Secretary of the Navy, Patuxent River, MD (US)

(21) Appl. No.: 15/928,703

(22) Filed: Mar. 22, 2018

(51) Int. Cl. G21B 1/05; G21B 1/17; G21B 1/21

(52) U.S. Cl. CPC G21B 1/05; G21B 1/21; G21B 1/17

(57) ABSTRACT

A plasma compression fusion device which includes a hollow duct and at least one pair of opposing counter-spinning dynamic fusors. The hollow duct includes a vacuum chamber disposed within the hollow duct. Each dynamic fusor has a plurality of orifices and an outer surface which is electrically charged. In combination, the pair(s) of dynamic fusors create a concentrated magnetic energy flux and electromagnetic radiation within the vacuum chamber, whereby the concentrated magnetic energy flux compresses a mixture of gases that are injected through the orifices to the vacuum chamber such that a plasma core is created, and the to electromagnetic radiation heats the plasma core, while produced magnetic fields confine the plasma core between the dynamic fusors, such that when an additional mixture of gases is introduced into the plasma core through the orifices, an energy gain is created.

### STATEMENT OF GOVERNMENT INTEREST

The invention described herein may be manufactured and used by or for the Government of the United States of America for governmental purposes without payment of any royalties thereon or therefor.

### BACKGROUND

Thermonuclear fusion involves the forcing together (unification) of light nuclei to form a heavier nucleus, which due to the mass defect occurs with generation of energy, as expressed in the E=mc² expression. Fusion occurs at extremely high temperatures, exceeding the core temperature of the Sun, which is approximately 15 million degrees Celsius. For example, the Deuterium-Tritium fusion reaction occurs at temperatures in excess of 175 million degrees Celsius, and the Deuterium-Deuterium fusion reaction occurs at approximately 232 million degrees Celsius. At these extremely high temperatures and pressures, a gas will ionize and form a plasma (the fourth state of matter), that is an ensemble of an enormous number of electrons and positive ions (≥10²⁰/m³), which constantly interact with each other, exchanging energy.

The three primary methods of confining plasma in order to make the ions fuse are gravitational confinement, inertial confinement, and magnetic confinement. In order to have fusion from gravitational confinement you need stellar-sized masses, thus inertial and magnetic confinement are the only practical methods, as well as possible hybrids of the two. Inertial confinement fusion is produced with laser-driven implosions or with electric fields (electrostatic), while magnetic confinement fusion is generated with extremely high magnetic induction in such configurations as tokamaks (devices that use a powerful magnetic field to confine plasma in the shape of a torus, which is a surface of revolution generated by revolving a circle in three-dimensional space about an axis coplanar with the circle), magnetic mirrors, magnetic cusps, pinches, and magnetized targets.

All these methods of plasma confinement have grave issues, such as an extremely large size (commensurate to that of an aircraft carrier) requirement, plasma instabilities for tokamaks, and power losses and short confinement times for magnetic mirror/cusp machines. None of these confinement methods to date have been able to achieve break-even fusion reactions, namely the condition for fusion power output to equal the power input, let alone achieve the ignition condition whereby a fusion plasma burn is self-sustained, without need for external power input. As a result, there is a need for an effective plasma compression fusion device, which creates an energy gain.

### SUMMARY

The present invention is directed to a plasma compression fusion device which includes a hollow duct and at least one pair of opposing counter-spinning dynamic fusors. The hollow duct includes a vacuum chamber disposed within the hollow duct. Each dynamic fusor has a plurality of orifices and an outer surface which is electrically charged. In combination, the pair(s) of dynamic fusors create a concentrated magnetic energy flux and electromagnetic radiation within the vacuum chamber, whereby the concentrated magnetic energy flux compresses a mixture of gases that are injected through the orifices to the vacuum chamber such that a plasma core is created, and the electromagnetic radiation heats the plasma core, while produced magnetic fields confine the plasma core between the dynamic fusors, such that when an additional mixture of gases is introduced into the plasma core through the orifices, an energy gain is created.

It is a feature of the present invention to provide a plasma compression fusion device that generates energy gain by plasma compression-induced nuclear fusion.

It is a feature of the present invention to provide a plasma compression fusion device that has the capability of maximizing the product of plasma pressure and energy confinement time in order to maximize energy gain and thus give rise to fusion ignition conditions.

It is a feature of the present invention to provide a plasma compression fusion device that can produce power in the gigawatt to terawatt range (and higher), with input power in the kilowatt to megawatt range.

### DRAWINGS

These and other features, aspects, and advantages of the present invention will become better understood with reference to the following description and appended claims, and accompanying drawings wherein:

FIG. 1 is a side cross sectional view of an embodiment (the cross-duct configuration) of the plasma compression fusion device;

FIG. 2 is a side cross sectional view of an embodiment (the linear-duct configuration) of the plasma compression fusion device; and,

FIG. 3 is a cross sectional side view of an embodiment of the dynamic fusor (the conical frustum configuration).

### DESCRIPTION

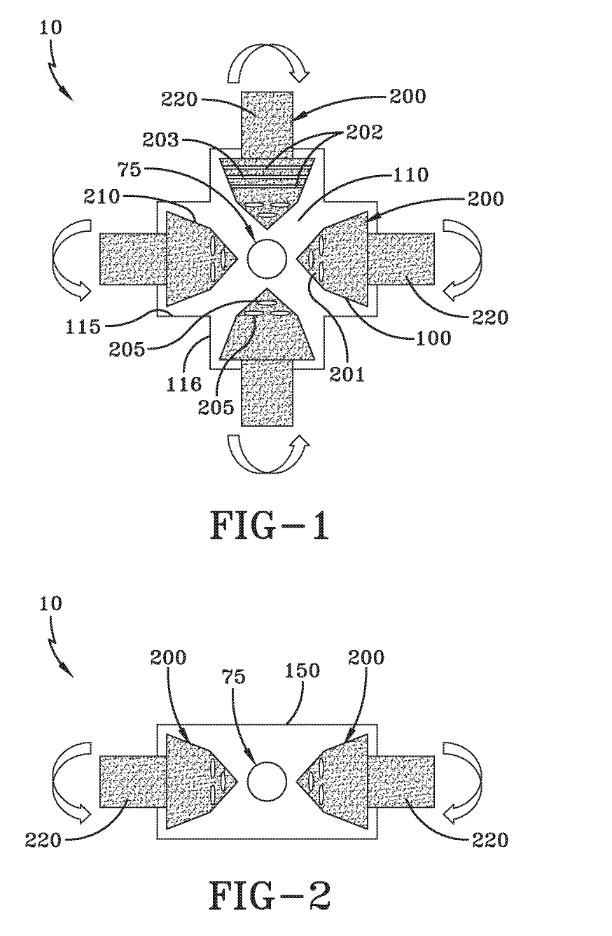

The preferred embodiments of the present invention are illustrated by way of example below and in FIGS. 1-3. As shown in FIG. 1, in one of the embodiments (referred to as the cross duct configuration), the plasma compression fusion device 10 includes a hollow cross-duct 100 and at least two pairs of opposing, smoothly curved-headed, counter-spinning conical structures 200 (which act as dynamic fusors). The hollow cross-duct 100 includes a vacuum chamber 110 disposed within the hollow cross-duct 100. Each opposing, smoothly curved-headed, counter-spinning conical structure 200 has a plurality of orifices 205 and an outer surface 210 which is electrically charged. In combination, the pair of counter-spinning conical structures 200 create a concentrated magnetic energy flux and electromagnetic radiation within the vacuum chamber 110, whereby the concentrated magnetic energy flux compresses a mixture of gases (the fusion fuel) that are injected through the orifices 205 to the vacuum chamber 110 such that a plasma core 75 (also can be referred to as a fusion plasma core, which is a substantially spherical and homogenous collective of electrons and positive ions) is created, and the electromagnetic radiation heats the plasma core 75, while produced magnetic fields confine the plasma core 75 between the counter-spinning conical structures 200, such that when an additional mixture of gases is introduced into the plasma core 75 through the orifices 205 an energy gain is created.

In the description of the present invention, the invention will be discussed in a space, sea, or terrestrial environment; however, this invention can be utilized for any type of application that requires the use of energy generation.

As shown in FIG. 2, in another embodiment of the invention (referred to as the linear duct configuration), the plasma compression fusion device 10 may include only one pair of to opposing curved-headed counter-spinning conical structures 200 disposed in a linear configuration within a hollow linear-duct 150. In general, the invention uses controlled motion of electrically charged matter via accelerated vibration and/or accelerated spin subjected to smooth yet rapid acceleration transients, in order to generate extremely high energy/high intensity electromagnetic fields, which not only confine the plasma but also greatly compress it is so as to produce a high power density plasma burn, leading to ignition and energy gain.

As shown in FIG. 1, the preferred embodiment includes two pairs of opposing curved-headed counter-spinning conical structures 200; however, more than two pairs of conical structures 200 may be utilized. The conical structures 200 may be generally referred to as dynamic fusors and be made from an alloy of Tungsten with high capacitance (such as Tungsten Nitride), or any other type of metal, alloy, or material practicable. Each conical structure 200, opposing each other in pairs, may have smoothly curved apex sections 201, and/or include assemblies of electrified grids 202 and toroidal magnetic coils 203. Each toroidal magnetic coil 203 may be disposed between at least two assemblies of electrified grids, arranged within each conical structure 200. The cross-duct 100 may include an inner surface 115 surrounding the plasma core 75. The inner surface 115 may be electrically charged and vibrated in order to prevent plasma particles from impacting the walls of the cross-duct 100 (particularly the inner surface 115) and initiating a plasma quench. The mixture of gases or fusion fuel, preferably Deuterium gas, is introduced into the plasma core 75 through the counter-spinning conical structures 200, namely injected through orifices 205 in the conical structures 200. The conical structures 200 are attached to corresponding hollow shafts 220, through which the mixture of gases or fusion fuel is pressure-fed from a gas reservoir(s) (not shown).

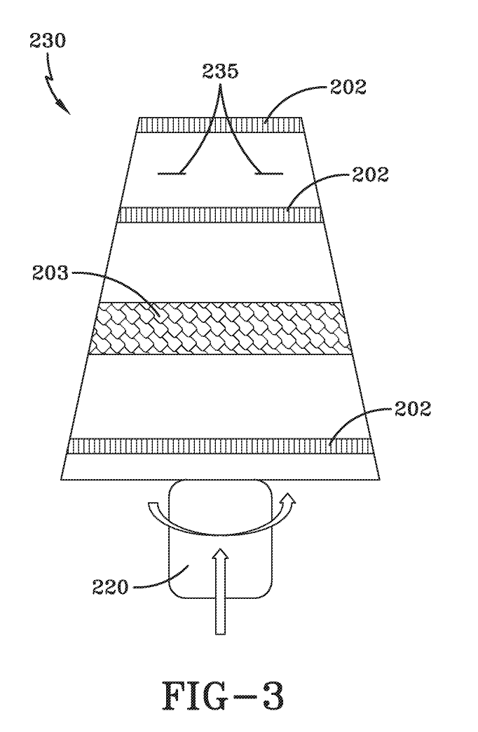

In an alternate embodiment, the dynamic fusors can also be dome-like or hemispherical in geometry. Alternatively, as shown in FIG. 3, the dynamic fusors may be conical frustums 230 or truncated cones having an isosceles trapezoidal cross section. The conical frustums 230 also include a plurality of orifices 235, and can include assemblies of electrified grids 202 (at least three) and at least one toroidal magnetic coil 203, arranged within each conical frustum 230. In general, the plurality of orifices 235 can be disposed within the electrified grids 202. As with all other embodiments of the dynamic fusor, each conical frustum 230 may have an outer surface that is electrically charged. Each toroidal magnetic coil 203 must be disposed between two electrified grids 202. The electrical grids 202 are used to ionize the Deuterium gas (or other fusion fuel in gaseous form) and are kept at different oppositely charged voltages so as to electrostatically accelerate either electrons or ions into the plasma core 75, depending on desired physical effect, in a manner similar to ion thrusters.

All dynamic fusor embodiments can be utilized in either the linear-duct configuration, the cross-duct configuration, or any type of duct configuration practicable. In the embodiments of the described dynamic fusors, the direction of the dynamic fusors 200, 230 or dynamic fusor spin is such that the generated magnetic flux always points towards the plasma core 75. The dynamic fusors 200, 230 can act as particle accelerators for electrons which are closely bound to the magnetic field lines of the toroidal coil 203, as well as to the magnetic field lines of the dynamic fusors 200, 230, once they exit each dynamic fusors 200, 230. These electrons are electrostatically accelerated through a set of two electrical grids 202 (one grid may be a positive voltage charge grid and another negative voltage charged grid, both having the ability to switch electrical charge) exhibiting a potential difference into the plasma core 75, forming a deep (high energy) negative potential well. This negative potential well greatly accelerates the positively charged ions toward it, and as the ions keep recirculating around the well, they undergo fusion. A high temperature, high pressure plasma core 75 results from the impingement of gas dynamic vortical plumes, which exhibit high viscous heating, as well as the intense collisions of electrons and positively charged ions which make up these plumes. In order to heat the plasma core 75 at the extreme temperatures that fusion requires, the electrically charged dynamic fusors 200, 230 generate high electromagnetic radiation by virtue of their accelerating spin. The inner surfaces of the dynamic fusors 200, 230 are well insulated against electrical charge migration, possibly, but without limitation, with silicon carbide, boron nitride, or boron carbide liners. An alloy of Tungsten (such as, but without limitation, Tungsten-nitride) with high capacitance, in order to hold an electric charge of a least one Coulomb, is the material of choice for the dynamic fusors 200, 230. Each dynamic fusor 200, 230 is mounted to a corresponding hollow shaft 220 (which can also be referred as a fusion fuel conduit), which is coupled to a variable power DC induction motor (not shown) and a gas reservoir (not shown), and can be accelerated-decelerated-accelerated in spin, via a digital controller (not shown).

In order for a fusion reaction to occur, we need to abide by the Lawson criterion, namely;

nTτ_{E}≥3×10²¹KeV s/m³ (Equation 1),

where n is the plasma density, T is the plasma temperature and, τ_{E} is the energy confinement time. Equation 1 illustrates that the higher the product of the plasma pressure with to the plasma energy confinement time, the higher the energy gain of the fusion reaction. The equal sign in Equation 1 represents the break-even condition, indicating an energy gain of one, which is the condition under which the fusion power output equals the reactor power input. Furthermore, it is important to note that if you double the strength of the magnetic field (double the magnetic induction B in units of Tesla), you half the linear size of the reactor, given other fusion parameters are held constant. Hence, being able to generate high magnetic induction (magnetic flux density) is extremely important in developing a compact fusion device.

There are two expressions which convey the importance of having high magnetic field induction, when it comes to plasma magnetic confinement for fusion, namely:

Energy Gain˜B³ (Equation 2)

and

Fusion Power Density˜P²˜B⁴ (Equation 3),

where P is the plasma pressure and B is the magnetic induction or magnetic flux density, given the condition that the ratio of plasma pressure and magnetic field pressure is on the order of unity.

At present there are few envisioned fusion reactors/devices that come in a small, compact package (ranging from 0.3 to 2 meters in diameter) and typically they use different versions of plasma magnetic confinement. Three such devices are the Lockheed Martin (LM) Skunk Works Compact Fusion Reactor (LM-CFR), the EMC² Polywell fusion concept, and the Princeton Field-Reversed Configuration (PFRC) machine.

The LM-CFR uses a magnetic mirror configuration in which toroidal magnetic coils featuring variable current generate magnetic field oscillations which heat a confined plasma. The Polywell device uses a hybrid plasma confinement and heating scheme by using both inertial electrostatic confinement and magnetic confinement within a polyhedral bi-conic mirror cusp geometry. The PFRC machine uses a unique radio-frequency heating scheme to induce rotating magnetic fields in order to confine plasma. These devices feature short plasma confinement times, possible plasma instabilities with the scaling of size, and it is questionable whether they have the ability of achieving the break-even fusion condition, let alone a self-sustained plasma burn leading to ignition.

The key to fusion rests with the achievement of extremely high magnetic fields, possibly exceeding 30 Tesla, which not even high temperature Rare Earth Barium Copper Oxide (REBCO)-type superconducting magnets, can readily generate at present. However, extremely high B-fields can be generated by controlled motion of electrically charged matter, via accelerated spin and/or accelerated vibration, subjected to rapid acceleration transients.

The plasma compression fusion device 10 utilizes controlled motion of electrically charged matter via accelerated vibration and/or accelerated spin subjected to smooth yet rapid acceleration-deceleration-acceleration transients, in order to generate extremely high energy/high intensity electromagnetic fields. These fields not only confine the plasma core 75 but also greatly compress it (by inducing a high energy negative potential well) so as to produce a high power density plasma burn, leading to ignition. The generated high intensity electromagnetic radiation heats the plasma core 75 and the produced magnetic fields confine it in between the dynamic fusors 200, 230. As described earlier, the duct inner surface 115 is electrically charged and vibrated in order to prevent plasma particles from impacting the walls (the duct inner surface 115) and initiating a plasma quench. Vibration can be achieved by passing an electrical current through piezoelectric films such as lead zirconate titanate (PZT) imbedded in the plasma compression fusion device 10 particularly in the inner surface 115. The plasma compression fusion device 10 may be housed in a Faraday cage for reasons of personnel safety. A 10-15 cm thick boron carbide (or Tungsten alloy) shielding which acts as the Faraday cage can also incorporate the cooling channels for the thermal conversion cycle, as well as provide the needed structural support and integrity to withstand the fusion-induced neutron bombardment. Plasma instabilities would be minimized and possibly suppressed by the shearing flows generated by the dynamic fusors 200, 230. The flow shearing would tear apart the vortical eddies responsible for the onset of turbulence within the plasma, which is regarded as the main source of plasma instabilities in a fusion reaction.

Fusion power output may be extracted via conformal heat exchangers (not shown), which are flush with the plasma compression fusion device 10 outer wall (which can be the duct outer surface 116) and carry the neutron produced heat to a thermoelectric generator via a cooling fluid, such as water or poly-alpha olefin (PAO). The mixture of gases and additional mixture of gases (both being the fusion fuel), preferably Deuterium gas, is introduced into the plasma core 75 through the dynamic fusors 200, 230, namely injected through the orifices 205, 235. Deuterium (heavy Hydrogen) can be abundantly extracted from sea-water; hence the ‘virtually limitless’ fuel source idea, that makes this invention extremely beneficial.

The fusion fuel (the mixture of gases and additional mixture of gases) can be neutronic or aneutronic. A neutronic fusion fuel can be a Deuterium-Tritium, Deuterium-Deuterium, Deuterium-Xenon mixture, or any gaseous mixture practicable. Both the mixture of gases and additional mixture of gases should be the same of the same chemical composition. The Deuterium-Xenon mixture can produce Xenon-129 with the release of two fast (highly energetic) neutrons which would greatly amplify the power output, however, consideration of the device wall degradation and enhanced radioactivity effects need to be considered from both an operational and a safety perspective.

An aneutronic fusion fuel can, but without limitation, be proton-Boron 11 (for fusion at more than 10× the fusion temperature of the neutronic fuel). In this case there will be no neutrons released, hence no radioactivity dangers arise. For the Hydrogen-Boron fuel, there is a one in one thousand chance of a Gamma-ray channel being formed, which in case of full operational status of the device, would demand great caution. Direct energy conversion is used in extracting fusion power from the plasma compression fusion device 10, since the products of this aneutronic fuel are three alpha particles (3 Helium-4 particles); hence, direct conversion of these charged particles via a hi-tech transformer is made viable. The main issue with the use of aneutronic fuel is that it demands a fusion temperature of 2 billion degrees Celsius (and higher), an almost 10× increase over neutronic fuel, such as the preferred Deuterium gas.

When utilizing Deuterium (²H) gas as the fusion fuel of choice, the following chemical reactions occur:

²H+²H→³H(1.01 MeV)+p+(3.02 MeV)[50%] (Equation 4) and

²H+²H→+³He(0.82 MeV)+n⁰(2.45 MeV)[50%] (Equation 5).

Thus, it is feasible to use both direct (electrical) and indirect (thermal) energy conversion by using deuterium gas, which is highly desirable from an operational viewpoint.

The plasma compression device 10 must be vacuum-pumped for fusion power to be effectively produced. An ultra-high vacuum on the order of 10⁻⁵ Torr is desirable, yet a lower quality vacuum may be used, given operational constraints on the device.

For the conditions of accelerated vibration or accelerated spin of an electrically charged object/system, the maximum EM energy flux (time rate of change of EM energy transfer per unit surface area) is:

Sₘₐₓ=f_{G}(σ²/ε₀)[(Rᵥv²)tₒₚ] (Equation 6),

where f_{G} is the charged system geometric shape factor (equal to 1 for a disc configuration), σ is the surface charge density, Co is the electrical permittivity of free space, Rᵥ is the vibration (harmonic oscillation) amplitude, v is the angular frequency of vibration in Hertz, and similarly in the case of axial spin Rᵥ is the effective system radius, while v represents the angular frequency of spin, and tₒₚ is the operational time for which the electrically charged system is operated at maximum acceleration (Rᵥv²). This closed form formulation is the result of the synthesis of classical electromagnetic field theory with the physics of simple harmonic motion. Furthermore, for the case of rapid time rates of change of accelerated vibration/spin (rapid acceleration transients) of the charged system, given that the time differential of acceleration is non-zero, we obtain:

Sₘₐₓ=f_{G}(σ²/ε₀)[(Rᵥv³)t²ₒₚ] (Equation 7).

Equation 7 indicates that, even with moderate vibrational/spins frequencies in a rapidly accelerating mode, the EM energy flux is greatly amplified. Moreover, this shows the extensive capabilities of a high energy/high frequency electromagnetic field generator, when used to heat plasma within the confines of the plasma compression fusion device.

When adding to the equation representing simple harmonic motion an “energy/momentum-pumping” (negative damping) term (bv), endemic of system acceleration, where b is a constant and v is (dx/dt), namely the speed of a vibrating mass (m), it can be shown that the maximum of the total energy (E_{T}) of the vibrating system can be written as:

E_{T}≈mRᵥ²Ω²[exp(2Ωt)] (Equation 8),

where Ω is the angular frequency of vibration, under the condition [(b/2 m)>>Ω₀ (natural frequency of vibration)], and t is time. Since the EM energy flux is directly proportional to E_{T}, we observe that there will be exponential growth in energy flux with accelerating vibration, especially under the condition of rapid acceleration transients.

Considering a classical Newtonian second law expression using the Lorentz (EM) force, we can relate the vibrating mass (m) with its vibrating charge (Q), in that m becomes directly proportional to the square of the ratio (Q/Ω). Coupling this relation with equation 8 yields:

Sₘₐₓ≈(Q²/ε₀)(Rᵥ²/Rₛ⁵)Ω[exp(2Ωt)] (Equation 9).

Equation 9 represents the maximum EM flux that can be achieved by accelerated vibration under the aforementioned condition, and applies to a spherical geometry (radius 1R) for a vibrating mass (m) of corresponding charge (Q). Note that the vibration in the electrically-charged device inner walls (of the cross-duct or linear duct) must be monitored so that it does not greatly exceed the natural vibration frequency of its component materials, since this can generate exponential growth in EM flux and may have deleterious effects on the plasma core, as well as on the structural integrity and operational safety of the device 10. Moreover, due to the conical geometry of the dynamic fusors 200, 230, the plasma fluid will assume the shape of vortex structures. Considering the force-free vortex expression of (curl v=Aᵥv), where v is the plasma fluid velocity and Aᵥ is a constant, which under certain conditions can be far greater than 1, from the physics of Equation 4, we can write:

B/Rᵥ˜curl B=AᵥB (Equation 10),

where Rᵥ is the effective vortex radius, so that as RR goes to zero, Aᵥ becomes a B-field amplification factor which mathematically can go to infinity. Physically this expresses the great amplification of the magnetic induction B-fields of the vortical plasma structures in the plasma core 75.

The maximum of magnetic field induction (B) for one of the dynamic fusors 200, 230 as a function of the angular frequency of spin (c) for each of the dynamic fusors can be written as:

B_{MAX}≈μ₀σR_{ω}ω³tₒₚ² (Equation 11),

where μ₀ is the magnetic permeability of free space (˜O(10⁻⁶)), σ is the surface charge density of the conical structure 200, R_{ω} is the effective spin radius of the dynamic fusor, and tₒₚ is the operational time at maximum acceleration of spin. For the condition of μ₀σR_{ω}tₒₚ²˜O(1), that is order of unity, we obtain B_{MAX}˜ω³, in other words, the maximum magnetic flux density scales with the cube of the angular spin frequency of the conical structure 200.

Since laboratory experiments have taken disc shaped objects of 10 cm in diameter and spun them at 10,000 rad/sec (100,000 RPM), with no apparent failure resulting from centrifugal loading, one can safely conclude that given the hardness of Tungsten from which each dynamic fusor 200, 230 is manufactured, it is possible to have values of w on the order of 104 rad/s. This means that a value for B_{MAX} on the order of 10⁶ Tesla is achievable by accelerated spin of the surface-charged conical structure 200, with a time differential of acceleration not equal to zero (smooth yet rapid spin acceleration—no abrupt/jerking motion required). Such high values of magnetic field induction (B) are feasible, as shown in peer-reviewed published papers by the inventor (Technical Paper AIAA 2017-5343 and Technical Paper SAE 2017-01-2040).

Taking into consideration Equation 2, the energy gain of the fusion reaction is on the order of 10¹⁸, meaning that possibility of fusion ignition, that is self-sustained plasma burn, is highly feasible, under the aforementioned conditions. As a result of this simple analysis, it is important to note that the present invention can produce power in the gigawatt to terawatt range (and higher) with input power in the kilowatt to megawatt range, and possibly lead to ignition plasma burn, that is self-sustained plasma burn without need for external input power, indicating the enablement of this invention.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the to preferred embodiment(s) contained herein.

What is claimed is:

1. A plasma compression fusion device comprising:
a hollow linear-duct having a vacuum chamber disposed within the hollow linear-duct;
one pair of opposing, smoothly curved-headed, counter-spinning conical structures disposed within the hollow linear-duct, each counter-spinning conical structure having a plurality of orifices and an outer surface which is electrically charged, and in combination the pair create a concentrated magnetic energy flux and electromagnetic radiation within the vacuum chamber, whereby the concentrated magnetic energy flux compresses a mixture of gases that are injected through the orifices to the vacuum chamber such that a plasma core is created, and the electromagnetic radiation heats the plasma core, while produced magnetic fields confine the plasma core between the counter-spinning conical structures, such that when an additional mixture of gases is introduced into the plasma core through the orifices, an energy gain is created.

2. A plasma compression fusion device comprising:
a hollow cross-duct having a vacuum chamber disposed within the hollow cross-duct;
at least two pairs of opposing, smoothly curved-headed, counter-spinning conical structures disposed within the hollow cross-duct, each counter-spinning conical structure having a plurality of orifices and an outer surface which is electrically charged, and in combination all the pairs create a concentrated magnetic energy flux and electromagnetic radiation within the vacuum chamber, whereby the concentrated magnetic energy flux compresses a mixture of gases that are injected through the orifices the vacuum chamber such that a plasma core is created, and the electromagnetic radiation heats the plasma core, while produced magnetic fields confine the plasma core between the counter-spinning conical structures, such that when an additional mixture of gases is introduced into the plasma core through the orifices, an energy gain is created.

3. The plasma compression fusion device of claim 2, wherein plasma compression fusion device further includes hollow shafts, each hollow shaft connected to a corresponding conical structure, the hollow shaft attachable to a gas mixture reservoir supplying the mixture of gas.

4. A plasma compression fusion device comprising:
a hollow cross-duct having a vacuum chamber disposed within the hollow cross-duct;
at least two pairs of conical frustums disposed within the hollow cross-duct, each conical frustum having a plurality of orifices and an outer surface which is electrically charged, and in combination all the pairs create a concentrated magnetic energy flux and electromagnetic radiation within the vacuum chamber, whereby the concentrated magnetic energy flux compresses a mixture of gases that are injected through the orifices to the vacuum chamber such that a plasma core created, and the electromagnetic radiation heats the plasma core, while produced magnetic fields confine the plasma core between conical frustums, such that when an additional mixture of gases is introduced into the plasma core through the orifices, an energy gain is created.

5. The plasma compression fusion device of claim 4, wherein each conical frustum includes assemblies of electrified grids and at least one toroidal magnetic coil, arranged within each conical frustum, each toroidal magnetic coil is disposed within a space between two electrified grids.
